(19) United States
(12) Patent Application Publication
(10) Pub. No.: US 2022/0229828 A1
(43) Pub. Date: Jul. 21, 2022

(54) SYSTEM AND METHOD FOR DETERMINING CREDIBILITY AND RELIABILITY OF SOCIAL MEDIA CONTENT

(71) Applicant: MediaVax, Inc., Chevy Chase, MD (US)

(72) Inventors: Glenn Lawyer, Letzebuerg (LU); Andrew L. Turscak, III, Salt Lake, UT (US); Robert J. Milletich, II, Yorktown, VA (US)

(21) Appl. No.: 17/580,799

(22) Filed: Jan. 21, 2022

Related U.S. Application Data
(60) Provisional application No. 63/139,865, filed on Jan. 21, 2021.

(51) Int. Cl. G06F 16/23; G06F 16/215

(52) U.S. Cl. CPC G06F 16/2365; G06F 16/215

(57) ABSTRACT

Embodiments of the present disclosure are directed towards a system and method for determining credibility and reliability of social media content. Embodiments may include receiving social media content from one or more social media applications, wherein the social media content includes a story, a source, and spread information. Embodiments may further include receiving a plurality of trusted global media inputs and analyzing, one or more of the social media content or the plurality of trusted global media inputs using machine learning. Embodiments may also include determining a score for one or more of the story, source, and spread information and generating a final score for the social media content based on the score.

### RELATED APPLICATIONS

The subject application claims the benefit of U.S. Provisional Application having Ser. No. 63/139,865, filed 21 Jan. 2021. The entire content of which is herein incorporated by reference.

### BACKGROUND

Disinformation on social media platforms is a real and growing problem. Widespread dissemination of false information undermines the foundations of our society and can lead to direct harm. For example, numerous sources (Atlantic Council's Digital Forensic Research Lab, the EU Disinformation Review, the German Marshall Fund's Alliance for Securing Democracy) implicate Russia, China and Iran state-sponsored actors as spreading false information which interferes with US elections.

Digital disinformation is made possible by technology. Bad actors can set up multiple social media accounts and use software to automate and coordinate postings and sharings of content. This allows them to achieve far greater dissemination of their “news” articles than would be possible otherwise.

### SUMMARY OF THE DISCLOSURE

The details of one or more example implementations are set forth in the accompanying drawings and the description below.

In an implementation of the present disclosure a system and method for determining credibility and reliability of social media content is provided. The method may include receiving social media content from one or more social media applications, wherein the social media content includes a story, a source, and spread information. The method may further include receiving a plurality of trusted global media inputs and analyzing, one or more of the social media content or the plurality of trusted global media inputs using machine learning. The method may also include determining a score for one or more of the story, source, and spread information and generating a final score for the social media content based on the score.

One or more of the following features may be included. The final score may include a source score, a story score, and/or a spread score. The method may further include providing instructions to display the final score at a graphical user interface. The method may also include automatically determining trustworthiness of a story. The method may further include automatically determining trustworthiness of a source. The trustworthiness of a story and/or a source may be based upon a plurality of features. The features of the story may include one or more of word choice, tweet nature, tweet performance, tweet construction, or grammar analysis.

In another implementation of the present disclosure a non-transitory computer readable storage medium having stored thereon instructions for determining credibility and reliability of social media content is provided. The instructions, which when executed by a processor result in one or more operations. Operations may include receiving social media content from one or more social media applications, wherein the social media content includes a story, a source, and spread information. Operations may further include receiving a plurality of trusted global media inputs and analyzing, one or more of the social media content or the plurality of trusted global media inputs using machine learning. Operations may also include determining a score for one or more of the story, source, and spread information and generating a final score for the social media content based on the score.

One or more of the following features may be included. The final score may include a source score, a story score, and/or a spread score. Operations may further include providing instructions to display the final score at a graphical user interface. Operations may also include automatically determining trustworthiness of a story. Operations may further include automatically determining trustworthiness of a source. The trustworthiness of a story and/or a source may be based upon a plurality of features. The features of the story may include one or more of word choice, tweet nature, tweet performance, tweet construction, or grammar analysis.

Numerous other features and implementations are also within the scope of the present disclosure.

### BRIEF DESCRIPTION OF THE DRAWINGS

FIG. 1 is a diagrammatic view of a distributed computing network including a computing device that executes an social media process according to an embodiment of the present disclosure;

FIG. 2 is a flowchart depicting operations of a social media process according to an embodiment of the present disclosure;

FIG. 3 is a diagrammatic view of social media process according to an embodiment of the present disclosure;

FIG. 4 is a graphical user interface associated with a social media process according to an embodiment of the present disclosure;

FIG. 5 is a graphical user interface associated with a social media process according to an embodiment of the present disclosure;

FIG. 6 is a graphical user interface associated with a social media process according to an embodiment of the present disclosure;

FIG. 7 is a graphical user interface associated with a social media process according to an embodiment of the present disclosure;

FIG. 8 is a graphical user interface associated with a social media process according to an embodiment of the present disclosure;

FIG. 9 is a graphical user interface associated with a social media process according to an embodiment of the present disclosure;

FIG. 10 is a graphical user interface associated with a social media process according to an embodiment of the present disclosure;

FIG. 11 is a graphical user interface associated with a social media process according to an embodiment of the present disclosure; and

FIG. 12 is a diagrammatic view of a client electronic device executing the social media process of FIG. 1 according to an embodiment of the present disclosure.

Like reference symbols in the various drawings indicate like elements.

### DETAILED DESCRIPTION

### System Overview

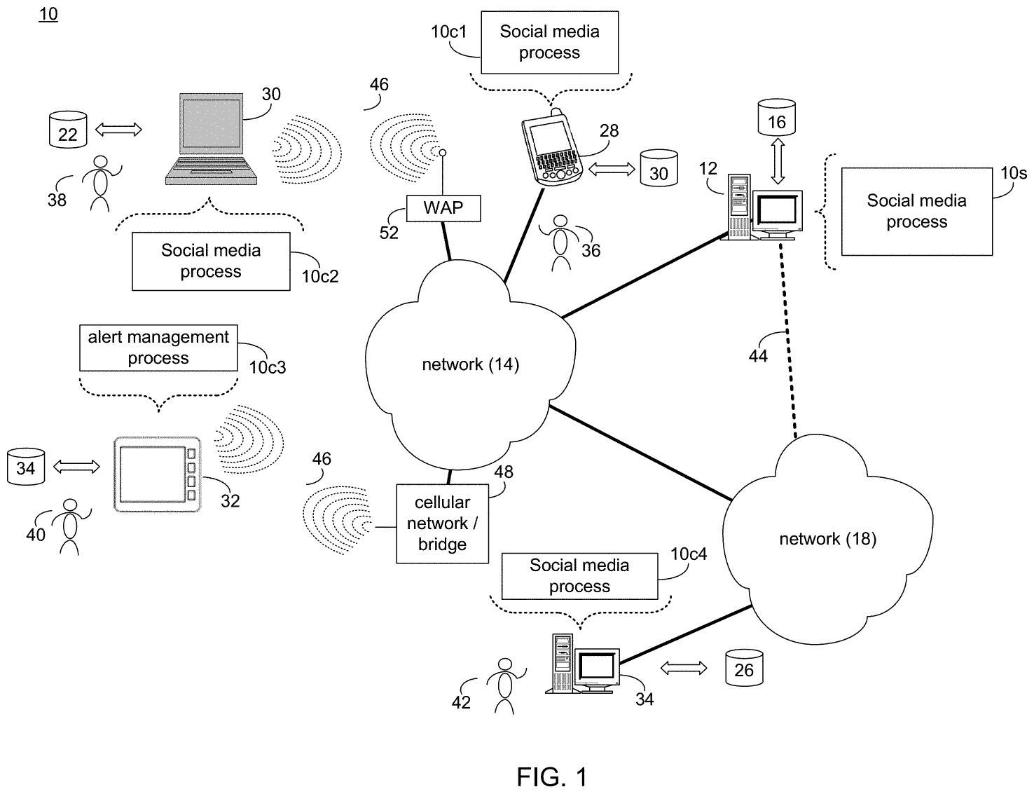

In FIG. 1, there is shown social media process 10. Social media process 10 may be implemented as a server-side process, a client-side process, or a hybrid server-side/client-side process.

For example, social media process 10 may be implemented as a purely server-side process via social media process 10s. Alternatively, social media process 10 may be implemented as a purely client-side process via one or more of social media process 10c1, social media process 10c2, social media process 10c3, and social media process 10c4. Alternatively still, social media process 10 may be implemented as a hybrid server-side/client-side process via social media process 10s in combination with one or more of social media process 10c1, social media process 10c2, social media process 10c3, and social media process 10c4. Accordingly, social media process 10 as used in this disclosure may include any combination of social media process 10s, social media process 10c1, social media process 10c2, social media process 10c3, and social media process 10c4.

Social media process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a cloud-based computing network.

The instruction sets and subroutines of social media process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of social media processes 10c1, 10c2, 10c3, 10c4 may include but are not limited to a corporate user interface, a web browser, or a specialized application (e.g., an application running on e.g., the Android™ platform or the iOS™ platform). The instruction sets and subroutines of social media processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to: smartphone 28; laptop computer 30; specialty device 32; personal computer 34; a notebook computer (not shown); a server computer (not shown); a dedicated network device (not shown); and a tablet computer (not shown).

Client electronic devices 28, 30, 32, 34 may each execute an operating system, examples of which may include but are not limited to Microsoft Windows™, Android™, iOS™, Linux™, or a custom operating system.

Users 36, 38, 40, 42 may access social media process 10 directly through network 14 or through secondary network 18. Further, social media process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, smartphone 28 and laptop computer 30 are shown wirelessly coupled to network 14 via wireless communication channels 44, 46 (respectively) established between smartphone 28, laptop computer 30 (respectively) and cellular network/bridge 48, which is shown directly coupled to network 14. Further, specialty device 32 is shown wirelessly coupled to network 14 via wireless communication channel 50 established between specialty device 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between specialty device 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth® is a telecommunications industry specification that allows e.g., mobile phones, computers, and personal digital assistants to be interconnected using a short-range wireless connection.

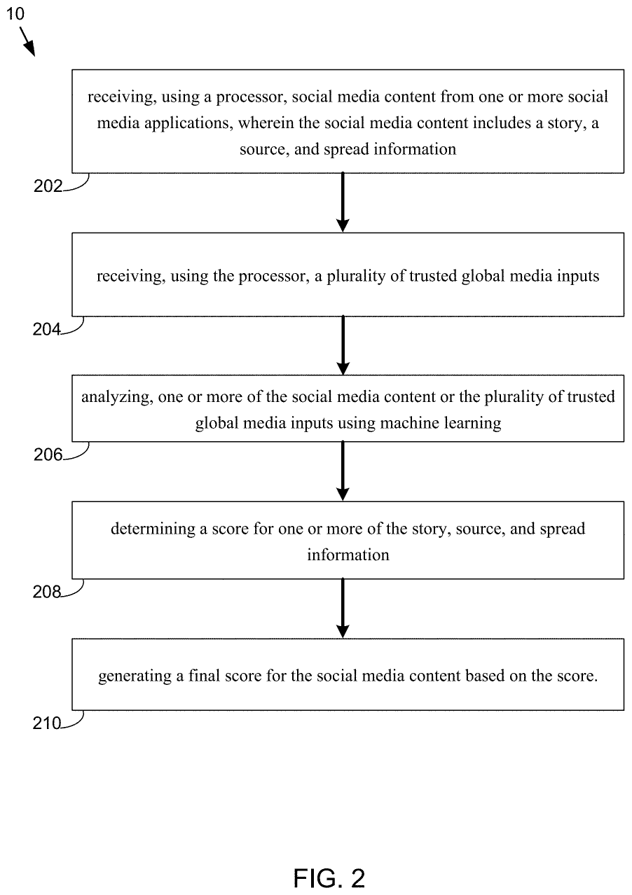

Referring now to FIG. 2, a flowchart 200 showing operations for determining credibility and reliability of social media content is provided. The method may include receiving (202) social media content from one or more social media applications, wherein the social media content includes a story, a source, and spread information. The method may further include receiving (204) a plurality of trusted global media inputs and analyzing (206), one or more of the social media content or the plurality of trusted global media inputs using machine learning. The method may also include determining (208) a score for one or more of the story, source, and spread information and generating (210) a final score for the social media content based on the score.. Numerous other operations are also within the scope of the present disclosure as is discussed in further detail hereinbelow.

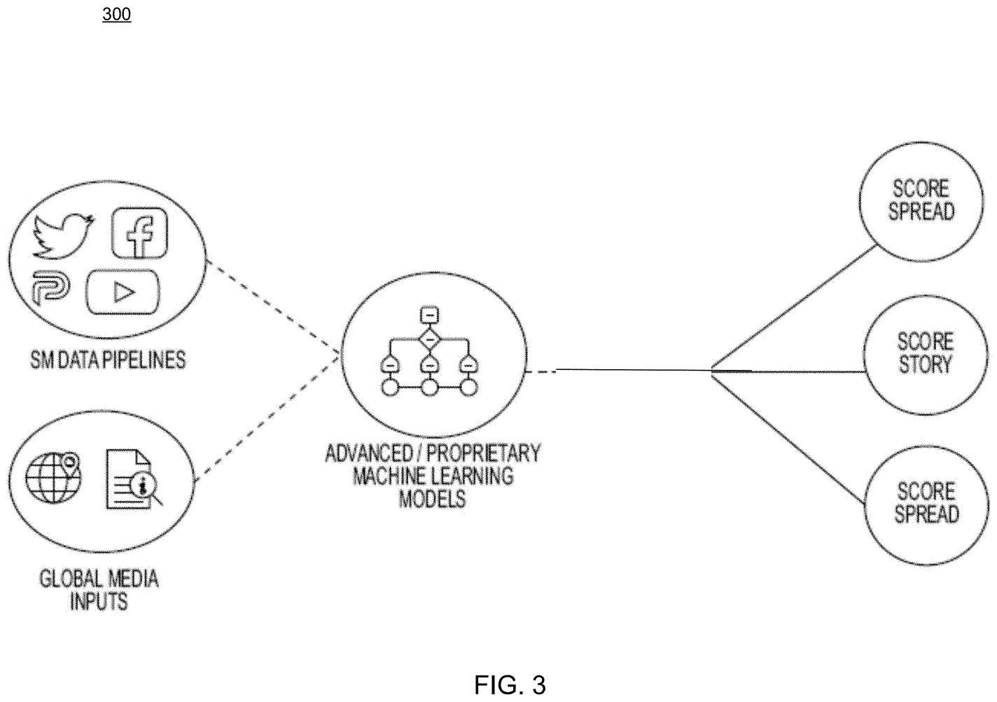

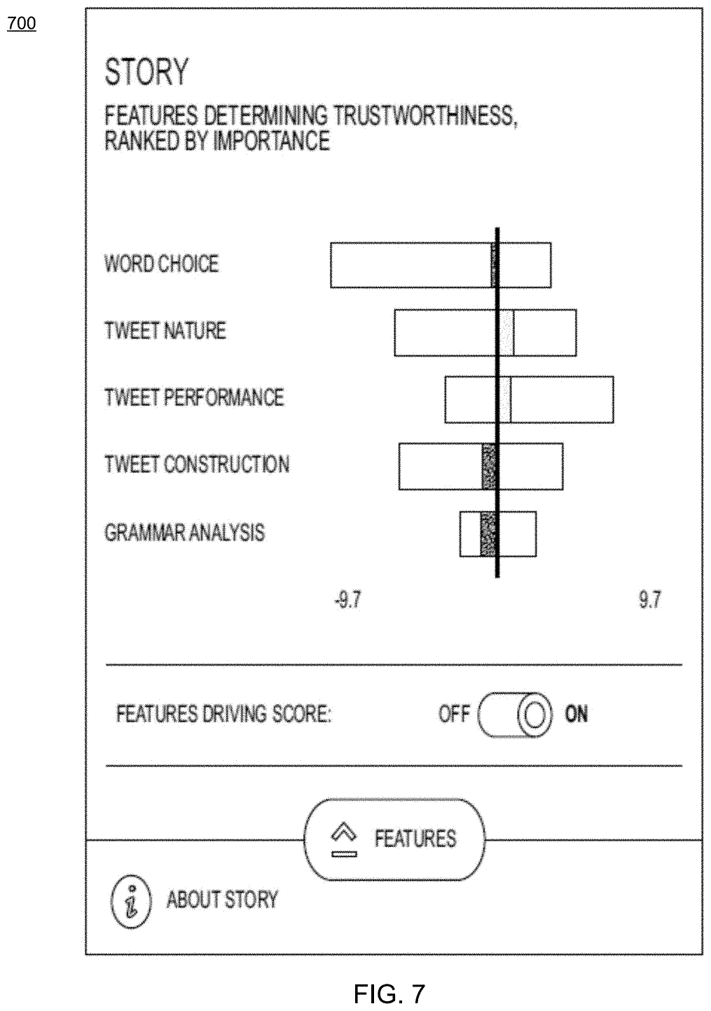

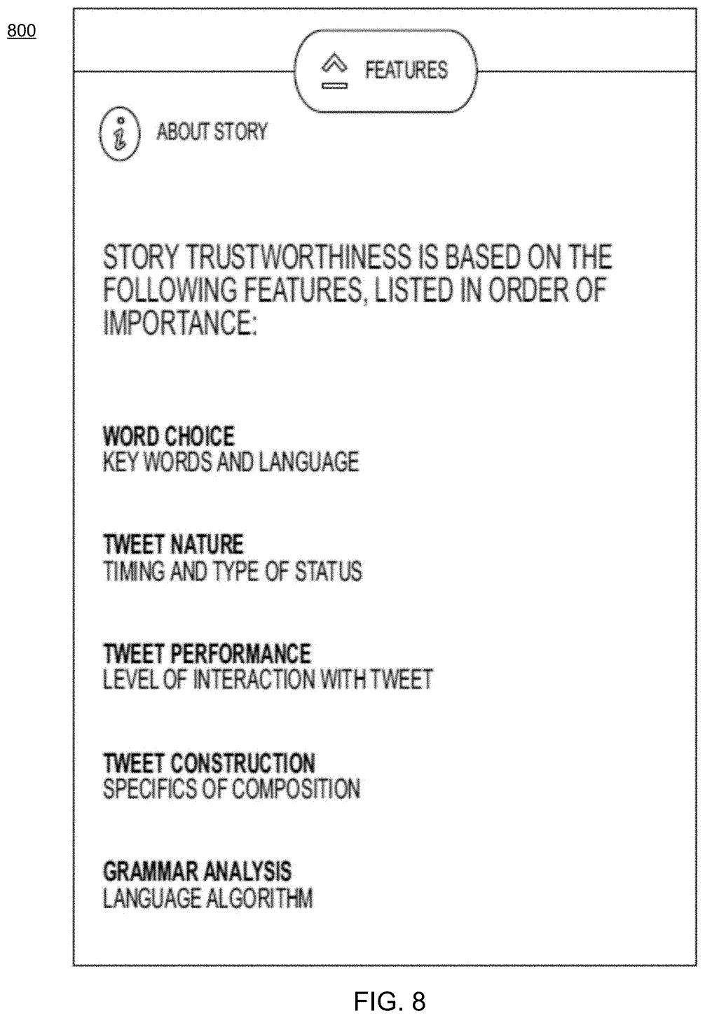

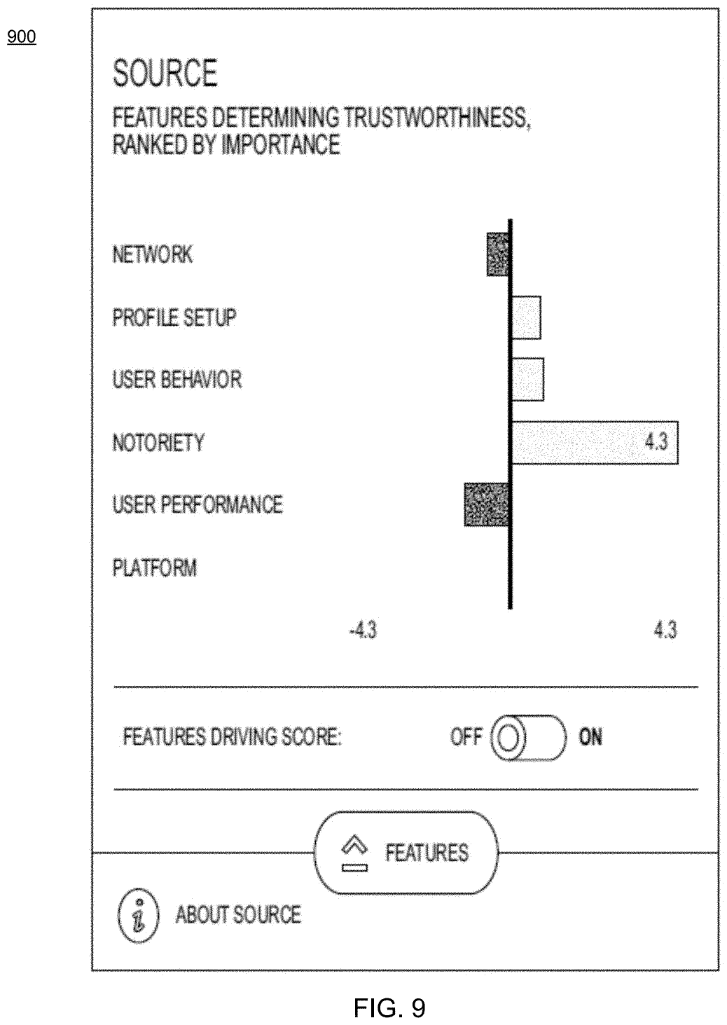

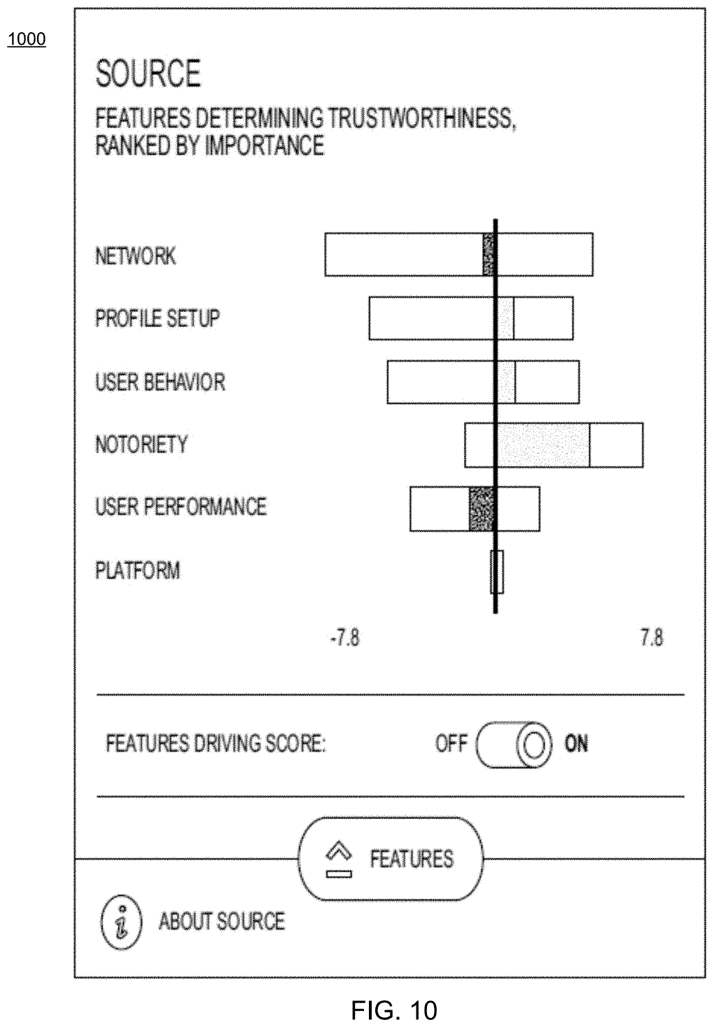

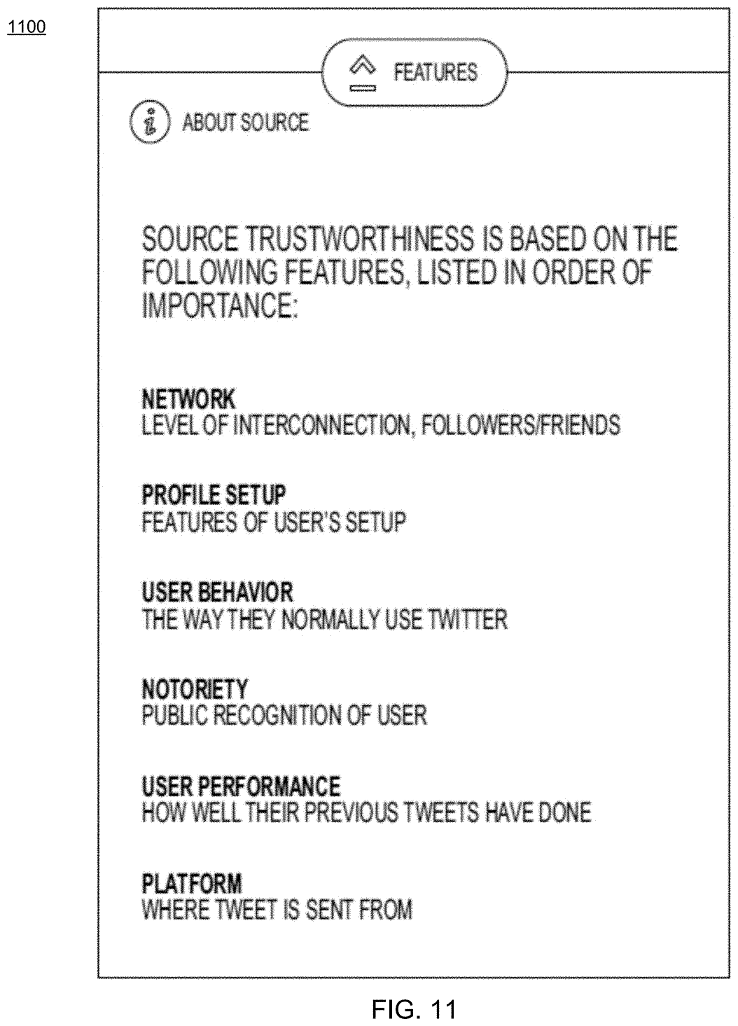

Referring to FIGS. 3-12 and as will be discussed in greater detail below, embodiments of the present disclosure provide an automated method for scoring the credibility/reliability of social media content.

As discussed above, digital disinformation is made possible by technology. Bad actors can set up multiple social media accounts and use software to automate and coordinate postings and sharings of content. This allows them to achieve far greater dissemination of their “news” articles than would be possible otherwise. Fortunately, technology also allows the automated detection of unreliable postings.

Disinformation does not spread at random on social media, instead, it may be spread by and/or within social groups. Thus, the reliability of the information may be determined by, at least, the face value of the post, the reputation of the account posting it, and by analyzing if its dissemination is reasonable. Accordingly embodiments included herein may be configured to assemble and integrate the necessary technical systems to enable systematic and large-scale determination of the reliability of individual social media posts.

Embodiments included herein propose a novel method for scoring on-line social media posts for reliability. We use the word “reliability” as a substitute for “truthfulness”, because a fake news story can contain truthful elements combined in such a way as to lead to a false conclusion. In some embodiments, the method may be focused on social media content which can be viewed as news or facts about the world. The method may be used to combat digital disinformation.

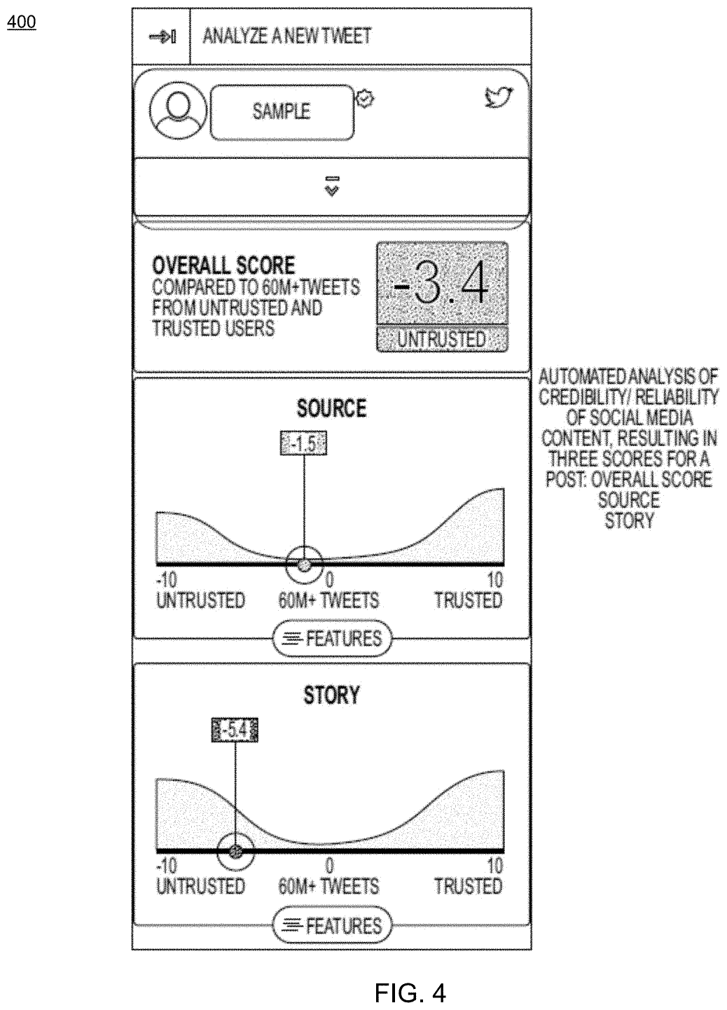

Referring now to FIG. 3, a diagram 300 showing an embodiment consistent with social media process 10 is provided. Embodiments included herein may evaluate one or more aspects of a social media post: the story, the source, and the spread. The “story” may be the content of the post, the “source” may be the account making the post, and “spread” may be characteristics of how the post is propagated on the social network. A combination of the subscores determined from one or more of these aspects of the social media post may result in calculating a reliability score. FIG. 4 shows an example graphical user interface 400 consistent with embodiments of social media process 10.

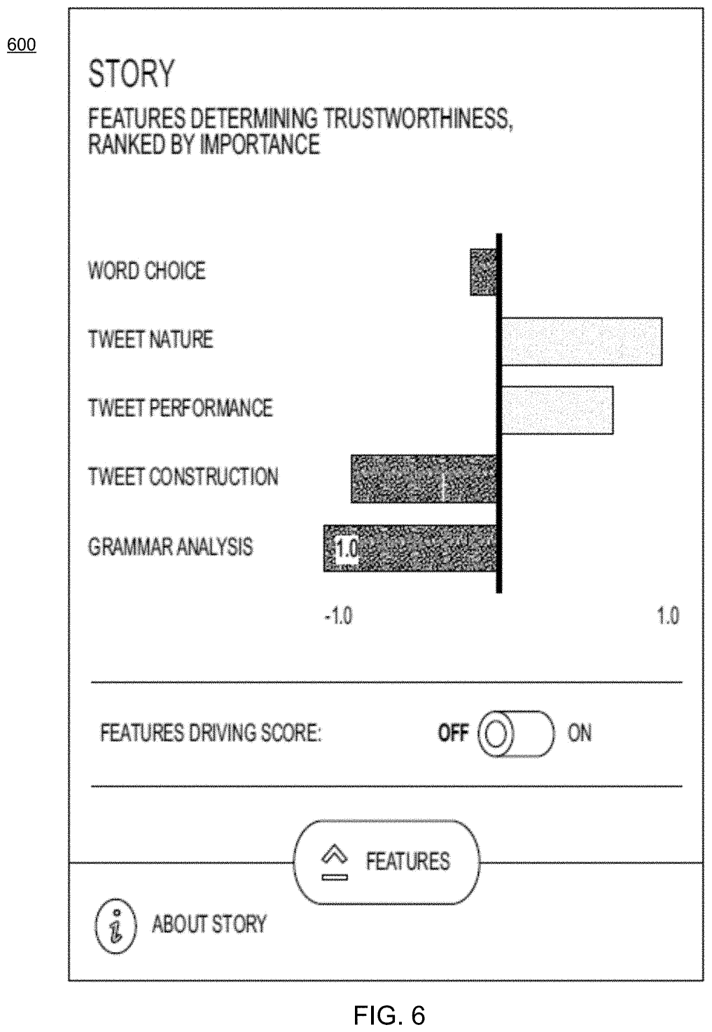

In some embodiments, social media process 10 may be configured to analyze the social media post content, the “story”. Without loss of generality, some embodiments may assume the content is text. In the case of audio content, the spoken words may be converted to text using any number of text-to-speech conversion algorithms. In the case of visually represented content, the same approaches described here for text have natural adaptations to visual medium. FIGS. 6-8 show various graphical user interfaces 600-800 depicting story displays.

In some embodiments, social media process 10 may include a large corpus of pre-categorized texts representing social media posts. Texts in the corpus may be labeled using any suitable label, including, but not limited to, “reliable”, “unreliable”, etc. Additional information may also be stored regarding the social media post, including, for example, an assignment to one or more topics, a record of the posting date, language included in the post, and/or region of origin of the post. This list is not exhaustive and other types of meta information are contemplated by this disclosure and may be stored.

In some embodiments, a new social media post may be rated on a reliability scale. In some embodiments, a new social media post may be rated on a reliability of −1 (e.g., fully unreliable) to 1 (e.g., fully reliable) based on, at least, its textual similarity to the texts in the corpus.

In some embodiments, social media process 10 may obtain the texts in the corpus from actual social media posts. Additionally and/or alternatively, the initial corpus may be manually curated. The corpus may be designed to be extended over time. New additions to the corpus may be manually curated. In other embodiments, the corpus may be extended by automatically adding new social media posts. The new social media posts automatically added may be based on the overall reliability score produced by embodiments disclosed here. Automated extension may occur fully automatically and/or with human oversight. Some embodiments may include a combination of manual curation and automatic additions of social media posts to the corpus.

In some embodiments, similarity can be measured by any number of natural language processing algorithms or other suitable approaches. For example, in some embodiments, a neural network (“deep learning”) architecture may be utilized. The neural network architecture may convert a text into a vector (e.g., 768-dimensional) and then measure the distance between the query text and the corpus texts in this space (e.g., 768-dimensional). Other embodiments may include utilizing n-grams, for example, but not limited to, n-gram frequencies of words and/or individual characters in the text. N-gram frequencies of words may look at the at whether “N” consecutive words appear in a text in comparison to the frequency of that combination in the target group, where N is an integer 1 or greater. For example, if N equals 2, social media process 10 may consider the frequency of each pair of words in the document.

In some embodiments, these algorithms may include additional pre-processing steps such as, for example, the removal of common words. Additionally, in some embodiments, the algorithm may consider a number of textual features. For example, social media process 10 may consider the semantic similarity of words (i.e. “cat” and “feline”). In other embodiments, social media process 10 may consider one or more of word choice, post length, grammar, spelling, non-word symbols such as emoticons, links, hashtags, and mentions. Numerous other features may also be extracted from the text.

In some embodiments, social media process 10 may measure the similarity of an input social media post to other posts in the corpus. The similarity measure may be calculated over all posts in the corpus. In other embodiments, the similarity measure may be restricted to a subset of posts based on topic, and/or an age cutoff (e.g., limiting the comparison to posts from the most recent 10 days). Additional filters, such as geographical region and/or language of the posts, may be added.

In some embodiments, the reliability score may be based on, at least, the top N similarity matches, where N may be a positive integer. An additional aspect of the reliability score may include the credibility of the source. Similarly to how the reliability of the story is measured, in some embodiments the credibility of the source may be measured based on similarity to items in a collection of sources with known credibility.

For example, known trusted sources may be hand-curated from social media accounts linked to organizations with high public trust and reputations for truthfulness. Known untrusted sources may be hand-curated from social media accounts linked to organizations with a documented tendency to promulgate false or misleading information. Other embodiments may restrict the collection of accounts with known credibility to accounts which have leadership roles in the communities they appeal to.

In some embodiments, social media process 10 may include the ability to extend the collection of labeled social media accounts by using automatic methods. For example, some embodiments may automatically extend the collection of labeled social media accounts by using the outputs of embodiments of the present disclosure. Automatic extension may focus on the detection of unreliable accounts. Detecting the unreliable accounts may be necessary because unreliable accounts are frequently removed by social media companies and/or abandoned by their creator. The person or organization behind the account may then create a new account to continue spreading disinformation.

In some embodiments, if an account is frequently found to post unreliable materials, as determined by social media process 10, then the account may be automatically added to the collection of unreliable accounts.

In other embodiments, social media process 10 may add an account to the collection of unreliable accounts based on the structure of accounts which it follows and/or which follow it. For example, if a large majority of an account's followers are labeled as “unreliable” by the invention, then the account may be considered “unreliable” and may be added to the collection of unreliable accounts. Likewise, if the account primarily follows unreliable accounts, it may be considered “unreliable.”

In some embodiments, newly-created unreliable accounts may be endorsed by other unreliable accounts, who tell their followers about the new account. In some embodiments, if an account is endorsed by a known unreliable account, it may be added to the collection of unreliable accounts.

In some embodiments, unreliable accounts added to the collection, by any approach, may be limited to accounts with leadership roles. For example, additions to the collection of unreliable accounts may be filtered by social media process 10 based on follower count.

Social media accounts allow the account holder to present several aspects of themselves in an account “profile”. Depending on the social media provider, the profile may include one or more items such as account name, a profile picture, a brief description of the account holder, the age of the account. Accordingly, embodiments of social media process 10 may include extracting one or more items from a social media profile. A profile may also include typical levels of account activity. In some embodiments, if levels of account activity information are not directly provided in the profile it may be obtained by tracking the account's activity patterns over a period of time, (e.g., over days and/or weeks). In some embodiments, similarity may be computed based on features extracted and/or tracked from the account profile.

In some embodiments, social media process 10 may obtain a list of which accounts a given account “follows”, and which accounts “follow” the given account. The distribution of credibility scores in following and followers may also provide information on the credibility of the account in question. This score does not have to be circular; for example, given a list of followers, the members of the list may be rated on credibility based on the account profile information. In some embodiments, social media process 10 may generate a summary count from how many accounts on the list tend to be credible vs non-credible based on profile information.

In some embodiments, social media process 10 may include augmenting the credibility of a target account by observing which social media posts or types of posts are endorsed and/or further distributed by the target account. The specific types of endorsements and/or further distribution observed by embodiments may vary across different social media platforms. An example of an endorsement would be “Like” on Facebook™. An example of further distribution would be a “retweet” on Twitter™. In some embodiments, if an account more consistently endorses and/or redistributes unreliable stories than reliable stories, then the source may be given a lower reliability score.

In some embodiments, social media process 10 may include analyzing the poster's recent social media posts for reliability. Additionally and/or alternatively, social media process 10 may include a final filter applied to the source's credibility score. For example, an important aspect of source credibility is if the account represents a real person or if it is a faked, automated bot account. Bot accounts may be automatically assigned a low credibility score.

In some embodiments, social media process 10 may be configured to distinguish bot accounts from human accounts based on statistical patterns. For example, for a bot account to be useful, its actions (e.g., frequency of posting, types of posts, following behavior, etc.) need to be statistically different than a natural person. Therefore, statistical irregularities may be used to rate an account based on how “human-like” or “bot-like” its behavior is. For example, specific aspects which signal a bot account may include, but are not limited to, extremely fast reposting of content and posting content on a fixed schedule (e.g., especially when that content is identical to a large number of other posts made at a similar time). In some embodiments, while the bot score may attempt to identify accounts which are actual bots, the accuracy of the bot score may not be a critical component. For the purpose of scoring the credibility of an account, if the account's activity is very similar to a bot, then the account may have a low credibility regardless of if it a human account or bot account.

In some embodiments, social media process 10 may be configured to calculate a source score. The “source” score may be calculated based upon a one or more of: an account profile, the credibility of the accounts linked to the target account (“follows” and/or “following”), the typical reliability of the posts endorsed by the account, the typical reliability of the original posts created by the account, and some embodiments may include adjusting for non-rateable posts, the typical credibility of accounts following the account and of accounts followed by the account, and/or if the account appears to be human or bot. It should be noted that these are provided merely by way of example as numerous other method may also be employed without departing from the scope of the present disclosure.

In some embodiments, an additional aspect of the reliability score may include the pattern of spread of the post. The pattern of spread may be viewed by looking at the temporal aspect of spread. Such analysis may include a review at the time between the original posting and some or all re-postings of the original content, where those reposting may also be re-postings of a prior re-posting, thus creating a chain of re-posts. This allows the computation of the rate of post spread at any one timepoint, the computation of changes to this rate of spread, and other time-based measures.

In some embodiments, the pattern of spread may also include an analysis of which accounts are re-posting the original content. This analysis could include reliability scores of the re-posting accounts, other qualities associated with the accounts, estimations of if the re-posting accounts are human or bots, etc. Again, the re-posting accounts may be some or all of the accounts re-posting, and may also include re-posts of re-posts. This allows computation of the types of accounts which are re-posting the original post.

In some embodiments, the pattern of spread may also include analysis of the network generated by re-postings, by tracking the connections between accounts which re-post the original content. Such analysis may include if re-posting accounts are otherwise connected within the social media platform, or if the accounts are otherwise linked.

In some embodiments, the pattern of spread may also be analyzed by some combination of time, which accounts, and the network connection between accounts reposting. As one illustrative example, the analysis might show that the early spread (re-posting) of a post was rapid and driven by bots in a tightly connected cluster, while the later spread was slower and predominantly mediated by humans in one specific geographical area.

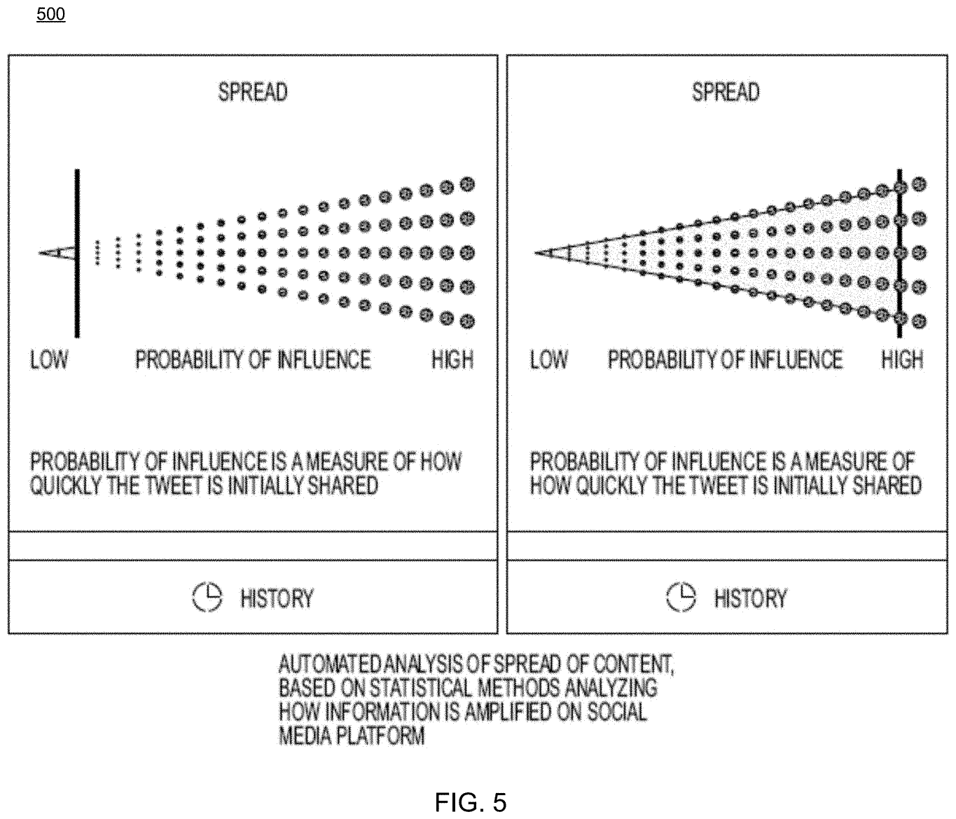

Referring also to FIG. 5 a GUI 500 is shown displaying information regarding spread of content. Accordingly, social media process 10 may perform automated analysis of spread of content, based on statistical methods analyzing how information is amplified on social media platforms.

In some embodiments, social media process 10 may be configured to calculate the likelihood that a post will be widely disseminated based on the time between reposting of the original post over a time period (e.g., the first 24 hours) from when the post was first made. Social media companies, when recording a post and/or a reposting, generally also record the timestamp of the (re)posting event. This data may be accessed in some embodiments via an application programming interface (“API”) call. The accessed data may allow retrieval of the posting times, and some embodiments may compute the time offset between repostings. In embodiments that compute the time offset between repostings, posts which show rapid acceleration (i.e. the time between repostings is short and grows shorter) may achieve widespread dissemination. If instead the time between repostings becomes longer, the post's dissemination may be waning.

In some embodiments, if a post does achieve widespread dissemination, social media process 10 may include an additional metric which determines if the spread is primarily in reliable or unreliable accounts. This metric may include a comparison of the time of first passage of a repost to a known reliable vs a known unreliable account. As used herein, the phrase “time of first passage” may be defined as the minimal time between when a post was first made and when it is reposted by an influential account. Because of the network structure of social groups, posts tend to move towards the most influential accounts in the social group. For example, if a post reaches an influential unreliable account faster than it reaches an approximately equally influential reliable account, it is almost certainly spreading primarily within unreliable accounts, and is thus more likely to be unreliable.

In some embodiments, social media process 10 may rely on a measure of node influence which accurately corresponds to the time it takes for a spreading process on a network to reach a given node. For example, a “node” in a “network” may correspond to an account (the node) on a social media platform (the network).

In other embodiments, the influence of the account may be determined using any suitable approach. These may provide a reliable and comparable measure of the influence of an account. In other embodiments, computing the influence of an account may be achieved by using an approximation to the metric based on a subsample of the local social network structure surrounding the account.

In some embodiments, social media process 10 may be configured to calculate the reliability score using a multi-pronged approach including multiple subscores. For example, the story alone may be insufficient because fake news generally may have some minimal level of plausibility in order to appear believable. Analyzing the source alone may be insufficient because unreliable content posters may make truthful posts. Analyzing spreading patterns alone may be insufficient because posts may be sometimes disseminated in unusual ways despite their content.

Embodiments of the present disclosure, may determine any assessments using statistical methods. This may allow these methods to be implemented as a process on a computer device (such as those shown in FIG. 1) and run on a large scale. In other embodiments, the scoring information may be incorporated into larger systems. For example, a journalist may use a computer implementation of the method to vet information on a rapidly emerging story. As an additional example, a social media company may use embodiments described here to place a score on each post it displays to an end user.

In some embodiments, social media process 10 may allow for fast, accurate reliability scores of social media posts, and may provide a valuable solution to the growing problem of disinformation spread using social media.

An example of an embodiment consistent with the present disclosure is provided in the following paragraphs. Other implementations are also possible, and the description herein is only for illustrative purpose and should not be construed as limiting.

For example, a user may enter a social media post into a web-form on a web-page. The form may transmit the post to a back-end system.

In some embodiments, a computer such as computing device 12 may analyze the content of the post to determine if it appears trustworthy. To do so, social media process 10 may compare the text with other texts from an internal database (e.g. the corpus of texts representing social media posts). Social media process 10 may also download other texts with keywords similar to the query text from social media sites, and compare the query text with these downloaded texts. Comparisons may be based on character and/or word frequencies, or on other statistical analysis of the text. If the comparison texts were known to be either reliable or not (or known to be obtained from reliable sources or not), then the similarity to reliable texts (or to common features of reliable texts) may be used to determine reliability. Additionally and/or alternatively, if the reliability of the comparison texts was not known to the system, social media process 10 may attempt to classify the query and the comparison texts by grouping them according to similarity. An assessment may then be made on the basis of the group of texts, or the ability to classify the texts. An unusual text would not classify with others, which could flag it as suspicious.

In some embodiments, social media process 10 may examine the information available on the holder of the social media account from which the text was taken. The account profile, or features of the profile, may be compared with features which are common on fake accounts. This may include one or more of a user name; profile photos; a number of followers and when they were added; how often and/or how regularly the account posts; which accounts share their posts; and how many topics the account posts about. This information may be used to assess if the account is human-like or bot-like.

In some embodiments, social media process 10 may examine a sampling of the account holder's posts for truthfulness using the approach presented above. Further, social media process 10 may maintain a database of accounts with suspicious behavior, allowing the account profile to be quickly checked against this database.

In some embodiments, social media process 10 may analyze the spread of the post (and similar posts) over the network. It could measure the proportion of new hashtags in the post. Social media process 10 may evaluate if the same new hashtag appeared suddenly on a number of new posts, all at about the same point in time. Social media process 10 may evaluate if similar posts are being made by multiple accounts at the same time, and if so, were these posts highly statistically similar (e.g., coordinated) or more conversational (e.g., a number of people presenting views on the same event as it unfolds). Social media process 10 may also evaluate the sharing speed. For example, when the post is shared, is the sharing instant or rather show a ½ second delay required for human interaction.

In some embodiments, social media process 10 may take these three assessments and it may combine them into a final score. The results may be returned to the user's web-page. The results may be displayed using one large gauge for the main score (e.g. the reliability score). The results may also include three smaller gauges for the subscores which contributed to the main score. Graphical representations of the factors and features which contributed to the score of the social media posts may be included to provide context for the user. Social media process 10 may provide the user a measure of how truthful the post was, and also some understanding of how they system came to that determination.

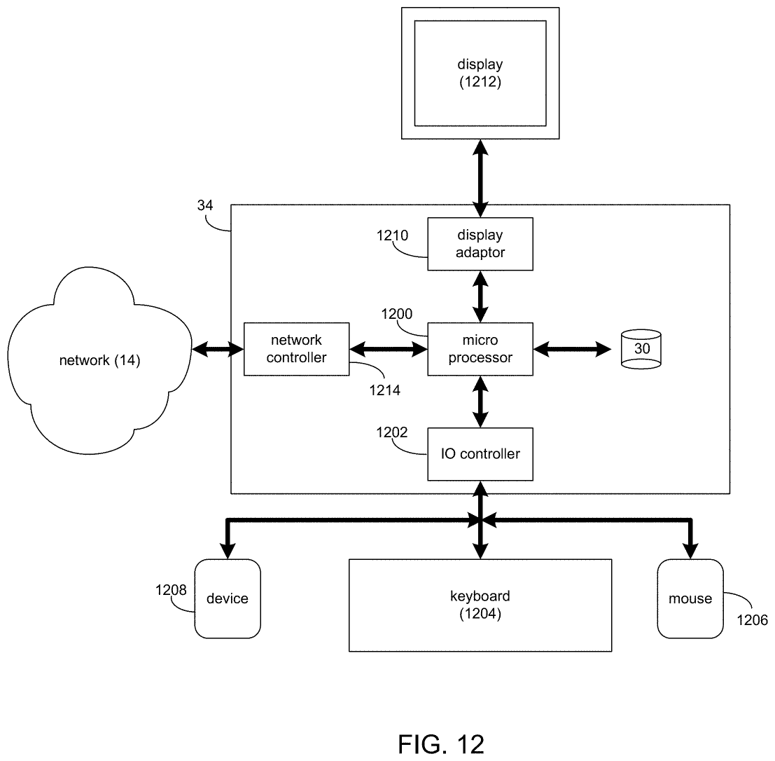

Referring also to FIG. 12, there is shown a diagrammatic view of an example client electronic device 34. While client electronic device 34 is shown in this figure, this is for illustrative purposes only and is not intended to be a limitation of this disclosure, as other configurations are possible. For example, any computing device capable of executing, in whole or in part, social media process 10 may be substituted for client electronic device 34 within FIG. 12, examples of which may include but are not limited to computing device 12 and/or client electronic devices 28, 30, 32.

Client electronic device 34 may include a processor and/or microprocessor (e.g., microprocessor 1100) configured to, e.g., process data and execute the above-noted code/instruction sets and subroutines. Microprocessor 1100 may be coupled via a storage adaptor (not shown) to the above-noted storage device(s) (e.g., storage device 26). An I/O controller (e.g., I/O controller 1102) may be configured to couple microprocessor 1100 with various devices, such as keyboard 1104, pointing/selecting device (e.g., mouse 1106), custom device, such a microphone (e.g., device 1108), USB ports (not shown), and printer ports (not shown). A display adaptor (e.g., display adaptor 1110) may be configured to couple display 1112 (e.g., CRT or LCD monitor(s)) with microprocessor 1100, while network controller/adaptor 1114 (e.g., an Ethernet adaptor) may be configured to couple microprocessor 1100 to the above-noted network 18 (e.g., the Internet or a local area network).

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method for determining credibility and reliability of social media content comprising:
receiving, using a processor, social media content from one or more social media applications, wherein the social media content includes a story, a source, and spread information;
receiving, using the processor, a plurality of trusted global media inputs;
analyzing, one or more of the social media content or the plurality of trusted global media inputs using machine learning;
determining a score for one or more of the story, source, and spread information; and
generating a final score for the social media content based on the score.

2. The method of claim 1 wherein the final score includes a source score.

3. The method of claim 1 wherein the final score includes a story score.

4. The method of claim 1 wherein the final score includes a spread score.

5. The method of claim 1 further comprising:
providing instructions to display the final score at a graphical user interface.

6. The method of claim 1 further comprising:
automatically determining trustworthiness of a story.

7. The method of claim 1 further comprising:
automatically determining trustworthiness of a source.

8. The method of claim 6 wherein trustworthiness of a story is based upon a plurality of features

9. The method of claim 7 wherein trustworthiness of a source is based upon a plurality of features.

10. The method of claim 8 wherein the features include one or more of word choice, tweet nature, tweet performance, tweet construction, or grammar analysis.

11. A non-transitory computer readable storage medium having stored thereon instructions for determining credibility and reliability of social media content, the instructions, which when executed by a processor result in one or more operations, the operations comprising:
receiving, using a processor, social media content from one or more social media applications, wherein the social media content includes a story, a source, and spread information;
receiving, using the processor, a plurality of trusted global media inputs;
analyzing, one or more of the social media content or the plurality of trusted global media inputs using machine learning;
determining a score for one or more of the story, source, and spread information; and
generating a final score for the social media content based on the score.

12. The non-transitory computer readable storage medium of claim 11 wherein the final score includes a source score.

13. The non-transitory computer readable storage medium of claim 11 wherein the final score includes a story score.

14. The non-transitory computer readable storage medium of claim 11 wherein the final score includes a spread score.

15. The non-transitory computer readable storage medium of claim 11 further comprising:
providing instructions to display the final score at a graphical user interface.

16. The non-transitory computer readable storage medium of claim 11 further comprising:
automatically determining trustworthiness of a story.

17. The non-transitory computer readable storage medium of claim 11 further comprising:
automatically determining trustworthiness of a source.

18. The non-transitory computer readable storage medium of claim 16 wherein trustworthiness of a story is based upon a plurality of features

19. The non-transitory computer readable storage medium of claim 17 wherein trustworthiness of a source is based upon a plurality of features.

20. The non-transitory computer readable storage medium of claim 18 wherein the features include one or more of word choice, tweet nature, tweet performance, tweet construction, or grammar analysis.
